(19) United States
(12) Patent Application Publication
(10) Pub. No.: US 2017/0041386 A1
(43) Pub. Date: Feb. 9, 2017

(54) PROVISIONING A TARGET HOSTING ENVIRONMENT

(71) Applicant: International Business Machines Corporation, Armonk, NY (US)

(72) Inventors: Badekila Ganesh Prashanth Bhat, Bangalore (IN); John Kurian, Bangalore (IN)

(21) Appl. No.: 14/818,367

(22) Filed: Aug. 5, 2015

(51) Int. Cl. H04L 29/08; H04L 29/06

(52) U.S. Cl. CPC H04L 67/1008; H04L 67/42

(57) ABSTRACT

A method for dynamically provisioning a target platform to host an application with one or more application program interfaces (APIs) is provided. The method determines whether one or more APIs are supported on one or more of at least two hosting platforms and whether one or more instructions for the application are permitted to be executed on the one or more of the hosting platforms, and executes the one or more instructions for the application on a supported and permissible platform having the lowest performance metric for running the application.

### BACKGROUND

The present invention generally relates to resource provisioning, and more particularly to resource provisioning in the platform as a service (PaaS) layer of a cloud computing environment.

The PaaS layer in a cloud computing environment may include multiple platforms with differing performance. For example, one platform may be IBM®'s zSeries® systems, which is deployed on IBM®'s proprietary mainframe architecture (herein collectively referred to as, “System Z”). Other platform examples include AIX®, Linux®, and Windows®, which may be deployed on a distributed network of traditional, non-System Z servers (herein collectively referred to as, “distributed platforms”). System Z provides various benefits over distributed platforms (e.g., as measured in performance metrics) including: higher quality of service (QoS) in terms of availability, scalability, response times, etc.; and support for more application program interfaces (APIs) and additional services. However, these benefits come with a cost. Typically, the cost of running an application on System Z is higher than the cost of running an application on a distributed platform.

Middleware lies between the underlying platform and the applications running on the platform and provides a hosting environment for the applications (e.g., IBM®'s CICS® hosting environment). Certain middleware products can virtualize a common hosting environment across multiple platforms, and thereby allow an application to run on multiple platforms, such as System Z and distributed platforms. For example, the CICS® hosting environment can be virtualized on System Z using CICS®-TS and on distributed platforms using IBM TXSeries® for Multiplatforms. Thus, utilizing these middleware products, a CICS® application can run on either System Z or a distributed platform. Other environments that can exist or be virtualized on System Z and distributed platforms include databases and Java runtime.

### SUMMARY

According to one embodiment of the present invention, a method for dynamically provisioning a target platform to host an application with one or more application program interfaces (APIs) is provided. The method may determine whether the one or more APIs are supported on one or more of at least two hosting platforms having different performance metrics and determine whether one or more instructions for the application are permitted to be executed on one or more of the hosting platforms. The method may execute the one or more instructions for the application on the target platform, which has a lowest performance metric for running the application among the one or more hosting platforms that supports the one or more APIs and on which the one or more instructions for the application are permitted to be executed.

According to another embodiment, a computer program product for dynamically provisioning a target platform to host an application with one or more APIs, where the target platform is selected from at least two hosting platforms having different performance metrics is provided. The computer program product may include at least one computer readable non-transitory storage medium having computer readable program instructions for execution by a processor. The computer readable program instructions include instructions for determining whether the one or more APIs are supported on one or more of the hosting platforms and whether instructions for the application are permitted to be executed on one or more of the hosting platforms, and executing the instructions for the application on a supported and permissible hosting platform having a lowest performance metric for running the application, which defines the target platform.

According to another embodiment, a system for dynamically provisioning a target platform to host an application with one or more APIs is provided. The system may include at least two hosting platforms, where the at least two hosting platforms have different performance metrics. The system may also include at least one processor, at least one computer readable memory, at least one computer readable tangible, non-transitory storage medium, and program instructions stored on the at least one computer readable tangible, non-transitory storage medium for execution by the at least one processor via the at least one computer readable memory. The program instructions include instructions for determining whether the one or more APIs are supported on one or more of the hosting platforms and whether instructions for the application are permitted to be executed on one or more of the hosting platforms, and executing the instructions for the application on a supported and permissible hosting platform having a lowest performance metric for running the application, which defines the target platform.

### BRIEF DESCRIPTION OF THE SEVERAL VIEWS OF THE DRAWINGS

The following detailed description, given by way of example and not intended to limit the invention solely thereto, will best be appreciated in conjunction with the accompanying drawings, in which:

FIG. 1 is a block diagram illustrating a common hosting environment spanning a System Z platform and a distributed platform;

FIG. 2 is a block diagram illustrating a method for provisioning a target platform, according to an aspect of the invention;

FIG. 3 is a flowchart illustrating a pre-deployment phase of the method for provisioning a target platform of FIG. 2, according to an aspect of the invention;

FIG. 4 is a flowchart illustrating a runtime phase of the method for provisioning a target platform of FIG. 2, according to an aspect of the invention;

FIG. 5 is block diagram illustrating the runtime phase of the method for provisioning a target platform of FIG. 4, according to an aspect of the invention;

FIG. 6 is a block diagram illustrating a dynamic policy manager, according to an aspect of the invention;

FIG. 7 is a block diagram illustrating a runtime behavior of the dynamic policy manager of FIG. 6, according at an aspect of the invention;

FIG. 8 is a block diagram illustrating an exemplary general purpose computer, according at an aspect of the invention;

FIG. 9 is a block diagram illustrating an exemplary cloud computing environment, according at an aspect of the invention; and

FIG. 10 is a block diagram illustrating functional layers of the exemplary cloud computing environment of FIG. 9, according to an aspect of the invention.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

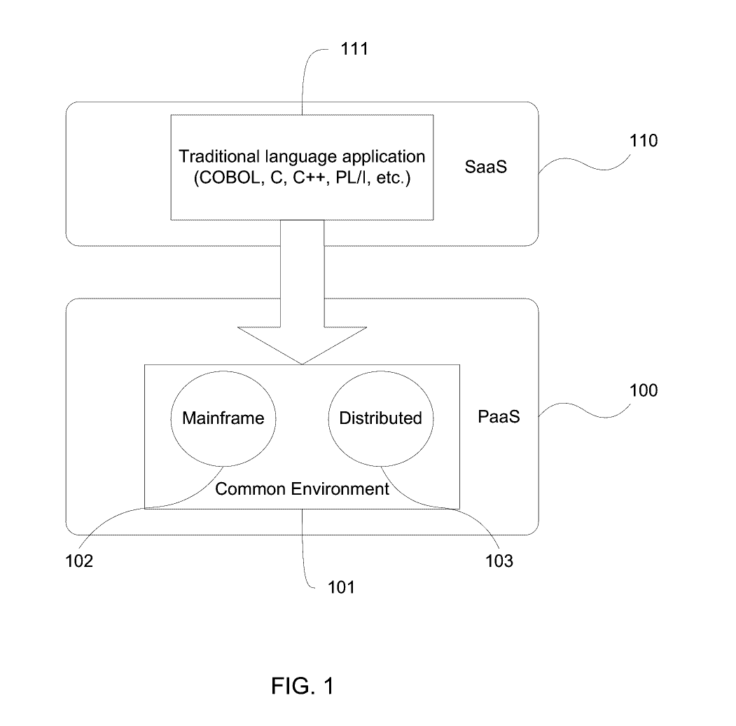

Various embodiments of the present invention will now be discussed with reference to FIGS. 1 through 10, like numerals being used for like and corresponding parts of the various drawings.

According to one embodiment of the present invention, a method is provided for dynamically and optimally provisioning middleware to host an application with one or more APIs in a PaaS layer of a cloud computing environment by executing one or more instructions of the application on a target platform having a lowest performance metric for running the application. Performance metrics can include metrics for QoS (e.g., response times for executing an instruction, scalability, availability, etc.), support for additional APIs and additional services, and security options.

According to another embodiment of the present invention, a method is provided for dynamically and optimally provisioning middleware to host an application with one or more APIs in a PaaS layer of a cloud computing environment by executing one or more instructions of the application on a target platform having the lowest cost implication for running the application. Cost implications can include charging models based on the cost of a million instructions per second (MIPS) or a monthly licensing charge (MLC). For example, a platform offering better performance metrics (e.g., better QoS and/or increased support for more APIs and additional services) will typically have a higher cost for a MIPS or a higher MLC compared to platform offerings with lower performance metrics.

FIG. 1 illustrates a block diagram representing a common hosting environment 101 in a PaaS layer 100, according to one embodiment of the present invention. The common hosting environment 101 spans multiple platforms, e.g., a mainframe platform 102 and a distributed platform 103. The common hosting environment 101 hosts application 111, which is in a Software as a Service (SaaS) layer 110 of a cloud computing environment. Application 111 may be any traditional application, e.g., written in COBOL, C, C++, PL/I, etc.

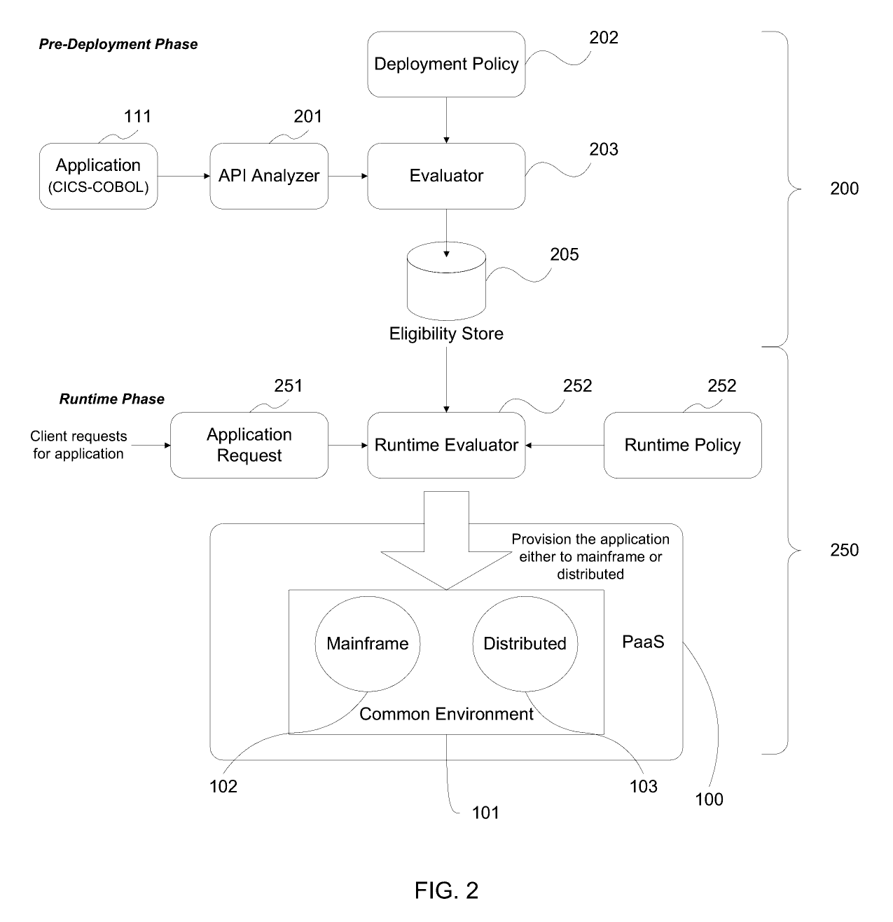

FIG. 2 illustrates a block diagram representing a method for provisioning a target platform, according to one embodiment of the present invention. In a pre-deployment phase 200, application 111 is analyzed by API analyzer 201, which scans application 111 for one or more APIs that may be supported by various platforms (e.g., a mainframe platform 102 and/or a distributed platform 103). The results of the analysis performed by API analyzer 201 are sent to evaluator 203, which in turn sends appropriate information to eligibility store 205. For example, if a first API is supported on a distributed platform, evaluator 203 may send to eligibility store 205 information that the first API is supported on a distributed platform. However, if the first API is not supported on a distributed platform, evaluator 203 may send to eligibility store 205 information that the first API is not supported on a distributed platform (e.g., by setting HostingEnvironment_Distributed=False). Evaluator 203 also analyzes the deployment policy 202 for application 111, which in turn sends appropriate information to eligibility store 205. Evaluator 203 may also, or in the alternative, send appropriate information to a database (not shown). In a preferred embodiment, evaluator 203 may be a cloud deployment manager.

With continuing reference to FIG. 2, in a runtime phase 250, a client requests an application 111 (e.g., application request 251), which is sent to runtime evaluator 252, which in response to the request, fetches application eligibility details for application 111 from eligibility store 205 and/or a database (not shown). Runtime evaluator 252 determines whether application 111 can run on various platforms (e.g., whether the APIs in application 111 are supported on distributed platform 103). Runtime evaluator 252 also analyzes a runtime policy 253 for application 111 to determine whether application 111 is permitted to run on various platforms (e.g., whether application 111 is permitted to run on distributed platform 103). Based on the evaluations and determinations by runtime evaluator 252, application 111 is executed on a target platform, which is in common hosting environment 101 that is hosted by one of the various platforms in the PaaS layer 100 (e.g., mainframe platform 102 or distributed platform 103). For example, the target platform may be a common environment hosted on a distributed platform.

Application 111 may be run on a target platform, or one or more instructions for application 111 may be executed on a target platform.

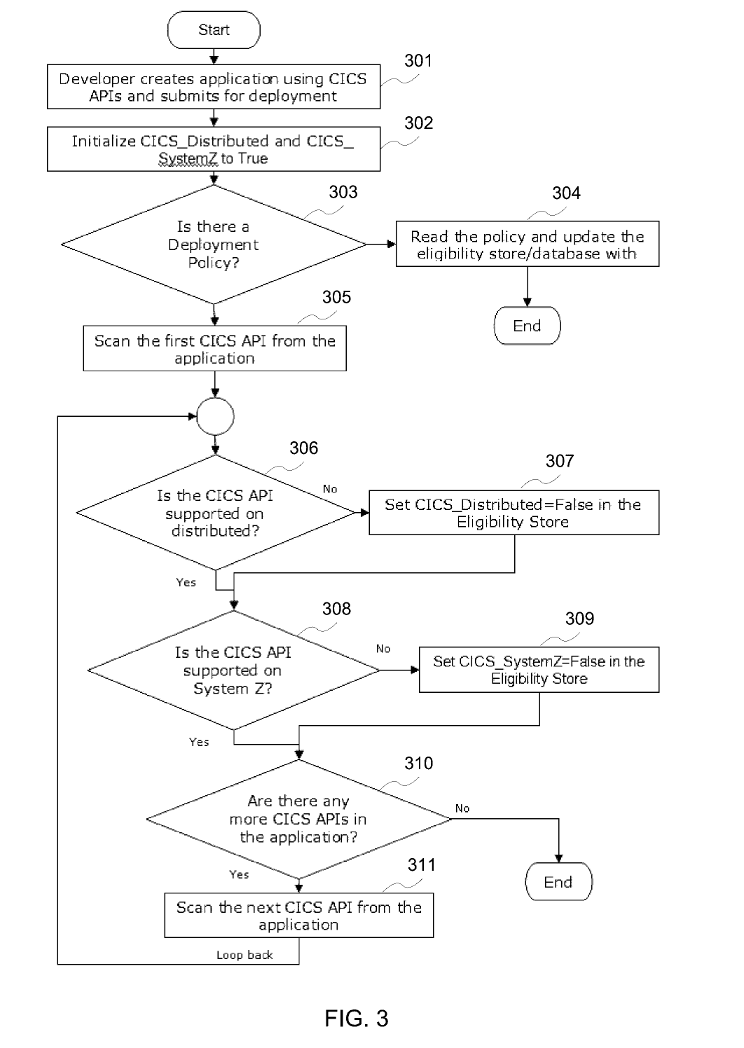

FIG. 3 illustrates a flowchart representing a pre-deployment phase of a method for provisioning a target platform, according to one embodiment of the present invention. At 301, a developer creates an application (e.g., using CICS® APIs) and submits the application for deployment (e.g., to be later accessed in a cloud computing environment). The application is then evaluated by an evaluator or a cloud deployment manager (e.g., 203 in FIG. 2).

With continuing reference to FIG. 3, at 302, the evaluator initially assumes that the application is eligible to run on either of two platforms provided in the PaaS (e.g., a System Z platform and a distributed platform). For example, the information in the eligibility store for the application is initially set to True for CICS_Distributed and CICS_SystemZ (e.g., CICS_Distributed=True, and CICS_SystemZ=True).

At 303, the evaluator determines whether the application includes a deployment policy. If the application includes a deployment policy, at 304, the evaluator reads the policy and updates the eligibility store and/or an appropriate database with information from the deployment policy.

At 305, the evaluator scans the application for a first API (e.g., a first CICS® API). At 306, the evaluator determines whether the first API is supported on a first platform in the PaaS (e.g., a distributed platform) and submits appropriate information to the eligibility store. For example, if the first API is not supported on a distributed platform, at 307, the evaluator sets CICS_Distributed=False in the eligibility store. If the first API is supported on a distributed platform, the evaluator determines whether the first API is supported on a second platform in the PaaS (e.g., a System Z platform), see 308. For example, if the first API is not supported on a System Z platform, at 309, the evaluator sets CICS_Distributed=False in the eligibility store. After determining whether the first API is supported on the two or more platforms, at 310, the evaluator determines whether there are any more APIs in the application. If so, the evaluator scans the application for the next API at 311 and the process of determining whether the next API is supported on the various PaaS platforms is repeated.

It should be noted that the steps described above were presented in the context of an evaluator or cloud deployment manager (e.g., 203 in FIG. 2) performing the steps; however, in other embodiments the steps in FIG. 3 may be performed by one or more other modules and/or devices in concert with, or instead of, the exemplary evaluator or cloud deployment manager. The order of the steps in FIG. 3 should not be considered limiting. For example, determining whether the application contains a deployment policy and reading the policy, etc. (e.g., 303, 304) may be performed after the application is scanned for APIs (e.g., 305-311). The order with which the application APIs are determined to be supported on various platforms should also not be considered limiting. For example, determining whether the API is supported on a distributed platform (e.g., 306) may occur after or simultaneously with determining whether the API is supported on a System Z platform (e.g., 308). Moreover, the present invention is not limited to two platforms and may include more than two platforms. For example, after determining whether the API is supported on a second platform (e.g., 308) and before determining whether there are additional APIs in the application (e.g., 310), the API may be analyzed to determine whether the API is supported on a third platform, fourth platform, etc.

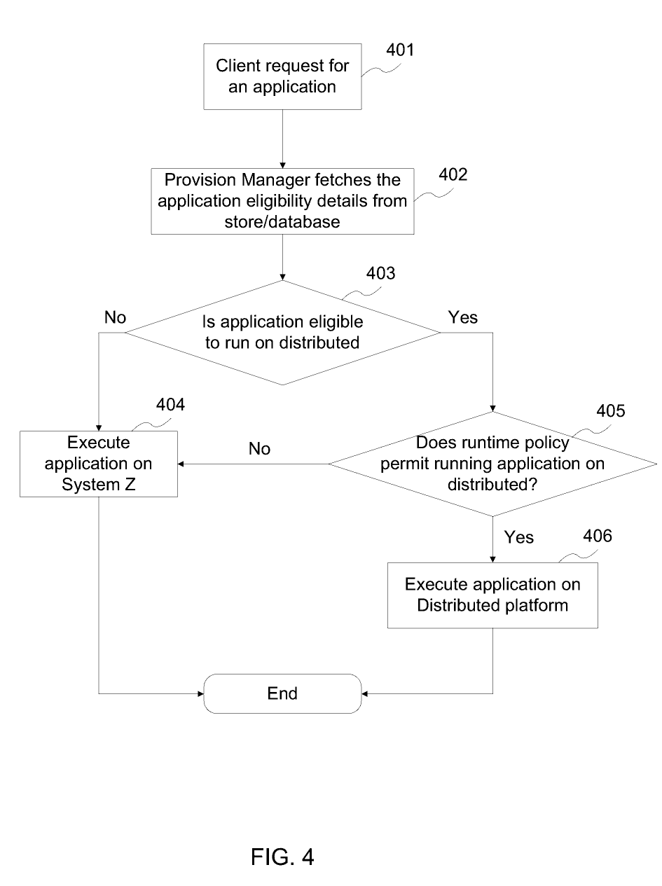

FIG. 4 illustrates a flowchart representing a runtime phase of a method for provisioning a target platform, according to one embodiment of the present invention. At 401, a client requests an application. At 402, a provision manager (e.g., a runtime evaluator, such as 252 in FIG. 2) fetches eligibility details for the application from the eligibility store and/or appropriate database(s). The eligibility details for the application may be information obtained during the pre-deployment phase, according to one embodiment of the present invention.

With continuing reference to FIG. 4, at 403, the provision manager determines whether the application is eligible to run on a first platform in the PaaS (e.g., a distributed platform). If not, the application is executed on a second platform in the PaaS (e.g., a System Z platform), see 404. If the application is eligible to run on the first platform in the PaaS (e.g., the distributed platform), then a runtime policy for the application is analyzed to determine whether the runtime policy permits running the application on the first platform (e.g., the distributed platform), see 405. If the application is permitted to run on the first platform, the application is executed on the first platform, see 406. If the application is not permitted to run on the first platform, the application is executed on the second platform (e.g., 404). The runtime policy can include runtime requirements such as a minimum response time (i.e., minimum time to process/execute an instruction), estimated transaction frequency (i.e., minimum bandwidth), scalability (e.g., a platform's ability to increase resources in response to increased demand), availability, etc.

It should be noted that the steps described above were presented in the context of a runtime evaluator or provision manager (e.g., 252 in FIG. 2) performing the steps; however, in other embodiments the steps in FIG. 4 may be performed by one or more other modules and/or devices in concert with, or instead of, the exemplary runtime evaluator or provision manager. The order of the steps in FIG. 4 should not be considered limiting. For example, it is contemplated that the runtime policy is analyzed (e.g., 405) before or simultaneously with determining whether the application is eligible to run on a particular platform (e.g., 403). Moreover, the present invention is not limited to two platforms (e.g., a distributed platform and a System Z platform) and may include more than two platforms. For example, in a scenario where three platforms are provided in the PaaS (e.g., low cost platform, medium cost platform, and System Z) a determination of whether the application is eligible to run on the low cost platform (e.g., 403) may be followed by a determination of whether the application is eligible to run on the medium cost platform, and if the application is not eligible or permitted to run on either the low cost platform or the medium cost platform, the application is executed on the System Z platform. The above scenario can similarly apply to three platforms having different performance metrics (e.g., a platform with low performance metrics, a platform with medium performance metrics, and a platform with superior performance metrics (e.g., System Z)). The performance metrics can be based on the overall performance metrics based on a comparison of a plurality of performance metrics for each of the hosting platforms. For example, a first and second platform may have comparable QoS and support for APIs and additional services, but differ in security options. The platform with the lower security options may be considered the platform with lower performance metrics. Other examples of platforms with differing performance metrics may correlate with different cost implications for running the application (i.e., a platform with lower performance metric(s) may also be a platform with lower cost implications for running the application).

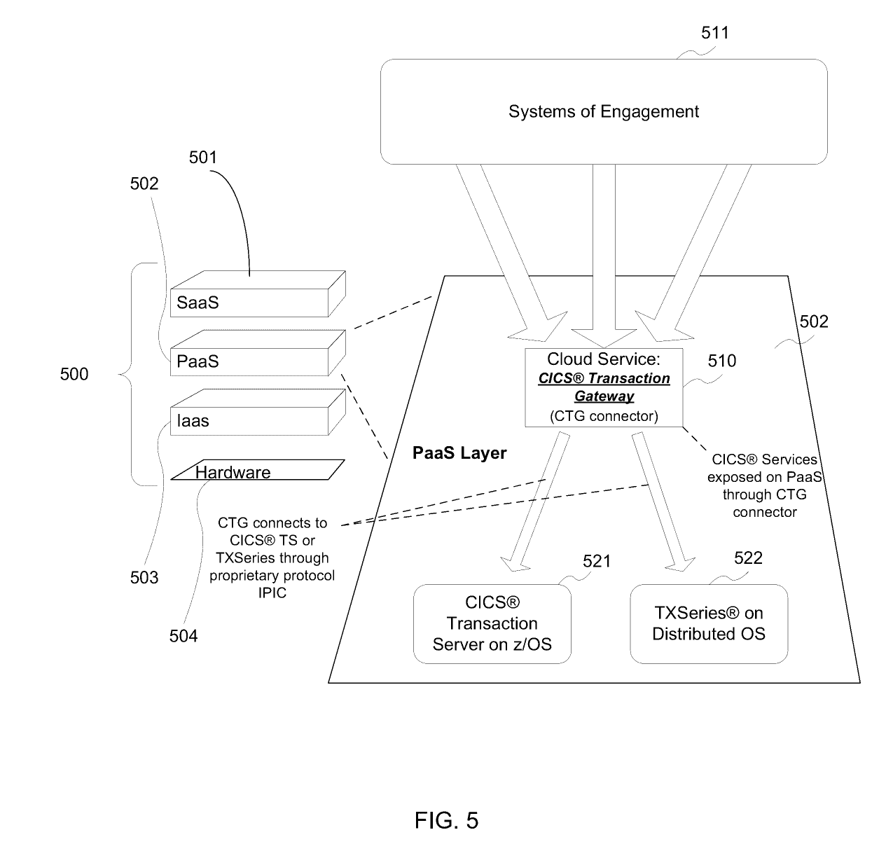

FIG. 5 illustrates a block diagram representing the runtime phase of the method for provisioning a target platform, according on one embodiment of the present invention. Cloud computing environment 500 includes three layers: software as a service (SaaS) 501; platform as a service (PaaS) 502; and infrastructure as a service (IaaS) 503. Underneath the IaaS layer is hardware 504. The PaaS layer can include a service, such as CICS® Transaction gateway (or CTG) 510, which is capable of dynamically switching between virtualized platforms of identical capability. CICS® services are exposed on the PaaS layer (via, e.g., IBM® SmartCloud Orchestrator/PureApplication System or BlueMix™). The CTG connector can dynamically route to the CICS® services either on a mainframe or on distributed platforms. Engaging with the exposed service is a system of engagement 511 (including various clients and/or cloud/application users). The CTG connects to CICS®-TS or IBM TXSeries® for Multiplatforms through proprietary protocol IPIC, 521 and 522, respectively. The IPIC protocol is supported on both a CICS® mainframe system (e.g., System Z) and an IBM TXSeries® for Multiplatforms distributed system. The CTG should be configured with the right end point (e.g., IP and port address) to communicate with the servers associated with the underlying platform/systems.

The CTG is a product that acts as a client to all CICS® type of application. The CICS® applications can either be hosted on a CICS®-TS environment (on System Z) or an IBM TXSeries® for Multiplatforms environment (on a distributed platform). The CTG can be hosted on a cloud PaaS platform like SCO/PureApplication System or BlueMix™.

An application that invokes a CICS® transaction for its business logic will implement the CTG APIs, and those APIs would invoke a corresponding CICS® application on the right CICS® “region” based on the configuration. One embodiment of the method of the present invention will serve as a decider for the right configuration to be supplied to the CTG. Thus, the transaction request is routed to the right place.

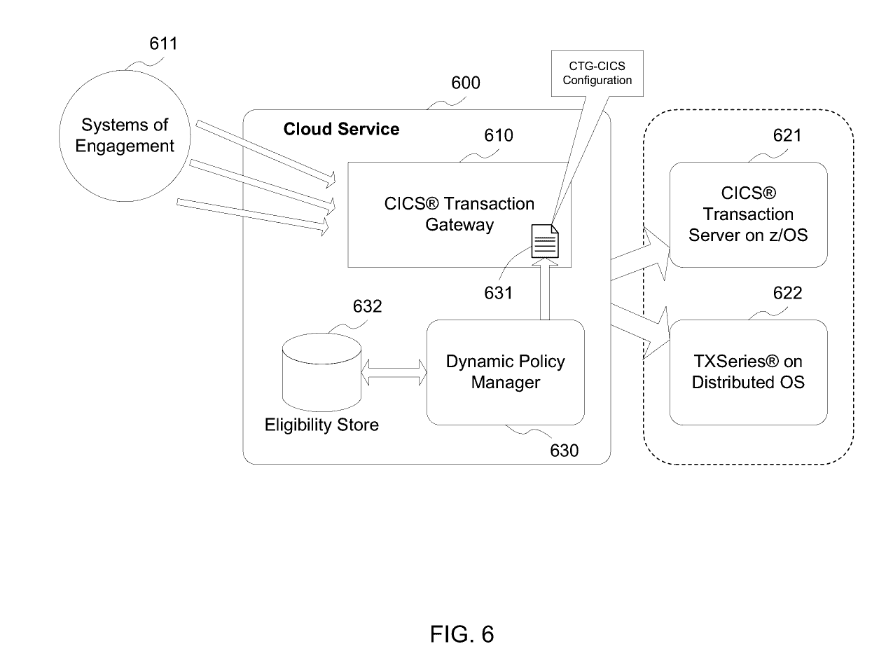

FIG. 6 illustrates a block diagram representing a dynamic policy manager, according to one embodiment of the present invention. A system of engagement 611 engages with CTG 610, within cloud service 600, which in turn routes transaction requests to either CICS®-TS on System Z 621 or IBM TXSeries® for Multiplatforms on a distributed platform 622. Dynamic policy manager 630 provides CTG 610 with CTG-CICS® configurations 631, which are based in part on application details obtained from the eligibility store 632. Dynamic policy manager 630 enables CTG 610 to dynamically optimize the CTG configuration based on the eligibility criteria and runtime expectations, such as transactions per second (TPS) and response time, APIs and associated services for the application, and criticality of the application.

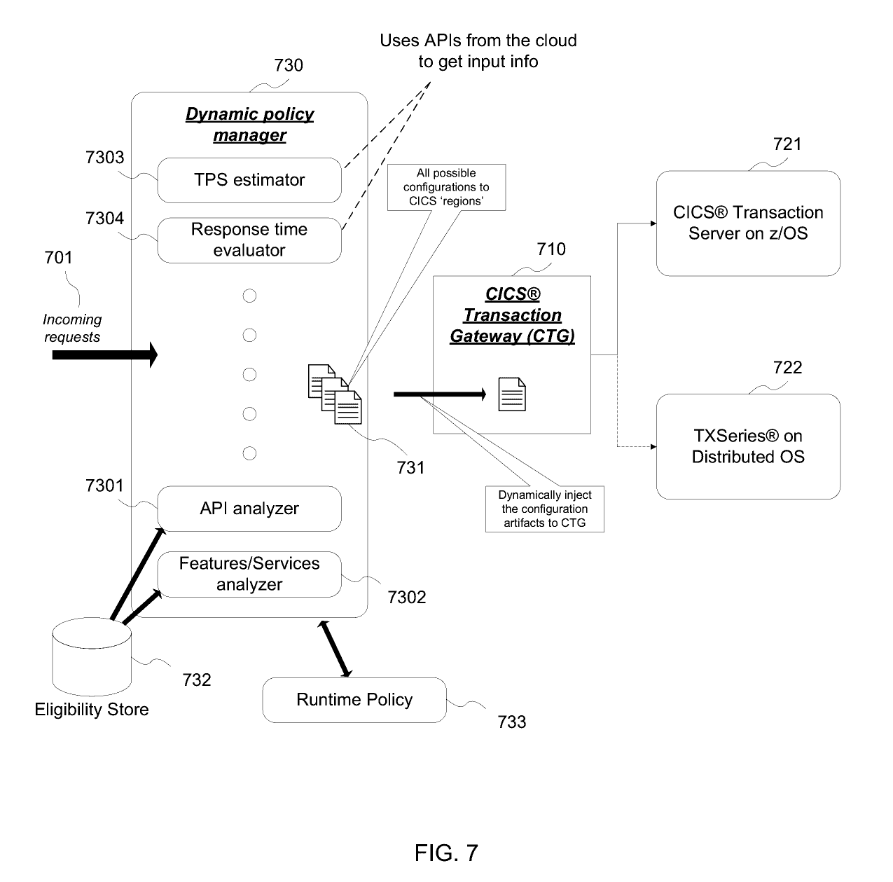

FIG. 7 illustrates a block diagram representing the runtime behavior of the dynamic policy manager, according to one embodiment of the present invention. Incoming request 701 (e.g., a request for an application) is directed to dynamic policy manager 730, which decides to run the application on a target platform (e.g., an eligible, permissible hosting environment with the lowest cost implication or the lowest performance metric for running the application). Dynamic policy manager 730 decides the target platform based on factors such as APIs used in the application, features/services used in the application, and response times and TPS restrictions set on the application. For example, dynamic policy manager 730 may include API analyzer 7301 and features/services analyzer 7302, which may obtain information from eligibility store 732. The dynamic policy manager 730 may also include a TPS estimator 7303 and response time evaluator 7304, which may obtain input information from APIs in the cloud computing environment. The dynamic policy manager 730 may also include information from the runtime policy 733 for the application.

The dynamic policy manager 730 may provide all possible configurations to CICS® “regions” 731 to the CTG 710, which routes incoming request 701 (e.g., a transaction request) to the target platform (either CICS®-TS on System Z, 721, or IBM TXSeries® for Multiplatforms on a distributed platform, 722).

An advantage of the present invention will now be described in the following, non-limiting, exemplary scenario. Retail service customers usually have licenses that allow them to run a predefined number of MIPS on a mainframe for a specified cost. However, during a peak shopping period (e.g., holiday shopping season around Christmas), a retail service customer may need additional MIPS on the mainframe as it expects more peak traffic. In such situations, an embodiment of the method of the present invention can be used to optimize the costs/demands for utilizing the mainframe, as described below.

In this exemplary scenario, a policy is defined where (a) some transactions will have an expected TPS and response time to be maintained; (b) some transactions are eligible to be moved to a distributed platform, while other transactions are mandated to be run on the mainframe platform based on the APIs or services used in the application; and (c) some transactions are maintained on the mainframe based on criticality. The eligible transactions can be switched to an IBM TXSeries® for Multiplatforms cloud instance dynamically. To achieve this, the following two action are taken: (1) a new light weight distributed IBM TXSeries® for Multiplatforms CICS® instance is deployed; and (2) the CTG configuration is updated dynamically at runtime so that requests are load balanced to IBM TXSeries® for Multiplatforms instances. Thus, the present invention allows the PaaS provider to provide optimal service to the retail service customer in the most efficient and/or cost-effective manner.

As described above, one embodiment of the present invention pertains to a common CICS® hosting environment spanning a System Z platform (mainframe platform) and a distributed platform. However, the present invention may be applied to other common hosting environments and platforms, especially when the other platforms are capable of running the same application, but have different cost implications (e.g., based on the APIs contained in the application) or different performance metrics. For example, the present invention may be applied to the following common hosting environments: P-Series versus X-Series; DB2® on a distributed platform versus DB2® on System Z; or Oracle® Tuxedo versus IBM TXSeries® for Multiplatforms.

According to one embodiment of the present invention, a method for dynamically and optimally provisioning middleware to host an application with one or more APIs in a PaaS layer is provided. The method may include providing in the PaaS at least two platforms capable of running the application, and the at least two platforms have different cost implications or different performance metrics for running the application. The method may determine whether the one or more APIs are supported on one or more of the at least two platforms and analyze a runtime policy for the application to determine whether the runtime policy permits one or more instructions for the application to be executed on one or more of the at least two platforms. The method may execute the one or more instructions for the application on one of the at least two platforms having a lowest cost implication for running the application, which defines a target platform. The target platform supports the one or more APIs and the runtime policy permits one or more instructions for the application to be executed on the target platform. The middleware for the method may include at least two middleware environments that are respectively associated with the at least two platforms.

In another embodiment, the at least two hosting platforms are provided in a PaaS layer of a cloud computing environment.

In another embodiment, one of the at least two hosting platforms is a mainframe platform. In a further embodiment, the mainframe platform provides higher QoS compared to other platforms of the at least two hosting platforms. In yet a further embodiment, at least one of the at least two hosting platforms is a distributed platform. In yet another further embodiment, the distributed platform has a lower cost implication based on the one or more APIs compared to the cost implication of the mainframe platform.

In another embodiment, the lowest performance metric for running the application is a lowest overall performance metric based on a comparison of a plurality of performance metrics for each the hosting platforms. The plurality of performance metrics can include metrics for QoS, support for additional APIs and/or services, and security. The lowest overall performance metric may correlate with the lowest cost implication for running the application. In another embodiment, the lowest overall performance metric correlates with the lowest cost implication for running the application. In one embodiment, the lowest performance metric can be a metric for QoS, support for additional APIs and/or services, and security. In one embodiment, the lowest performance metric is a metric for QoS.

In another embodiment, the determining whether one or more instructions for the application are permitted to be executed on one or more of the hosting platforms and the executing the one or more instructions for the application on the target platform are repeated in response to each incoming request to execute the one or more instructions for the application.

In another embodiment, the method of the present invention includes scanning the application for the one or more APIs (i.e., determining whether the application has one or more APIs).

In another embodiment, the application includes a runtime policy, and the determining whether one or more instructions for the application are permitted to be executed on the one or more of the hosting platforms includes analyzing the runtime policy.

In another embodiment, the method includes providing at least two middleware environments that are respectively associated with the at least two hosting platforms.

In another embodiment, the method of the present invention includes scanning the application for associated services and features (i.e., determining whether the application has associated services/features), and determining whether the associated services and features are supported on the one or more of the hosting platforms, and the target platform supports the associated services and features.

In another embodiment, the method of the present invention includes evaluating response times from the hosting platforms, and estimating transaction frequency information from the hosting platforms.

In another embodiment, a method for dynamically and optimally provisioning a target platform to host an application with one or more application program interfaces (APIs) is provided. The method may determine whether the one or more APIs are supported on one or more of at least two hosting platforms having different cost implications for running the application, and determine whether one or more instructions for the application are permitted to be executed on one or more of the at least two hosting platforms. The method may execute the one or more instructions for the application on one of the at least two hosting platforms having a lowest cost implication for running the application, which defines the target platform. The target platform supports the one or more APIs and the one or more instructions for the application are permitted to be executed on the target platform.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows. On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows. Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows. Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

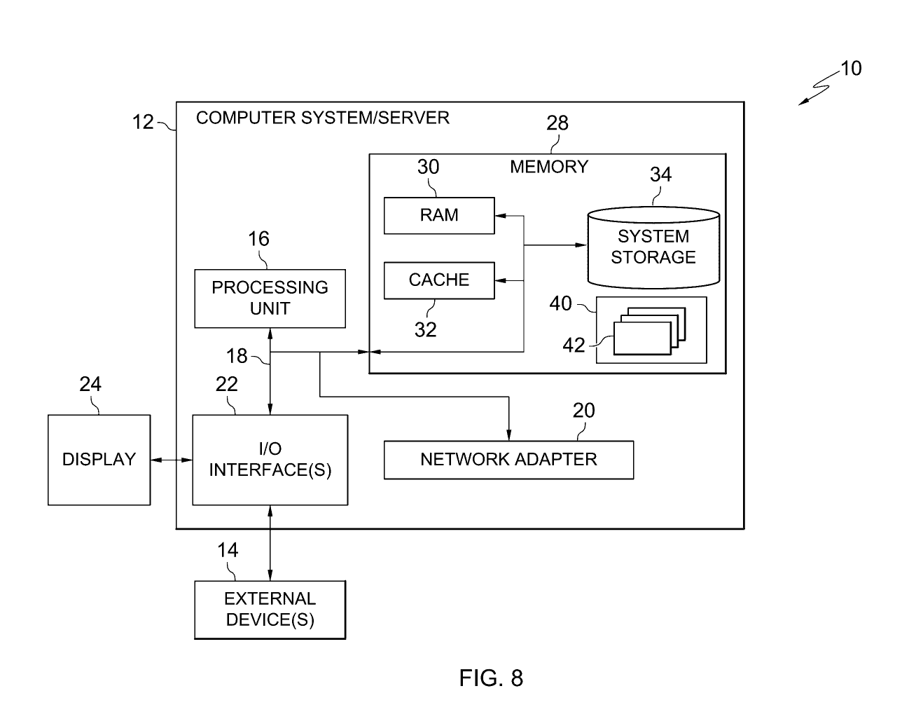

Referring now to FIG. 8, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

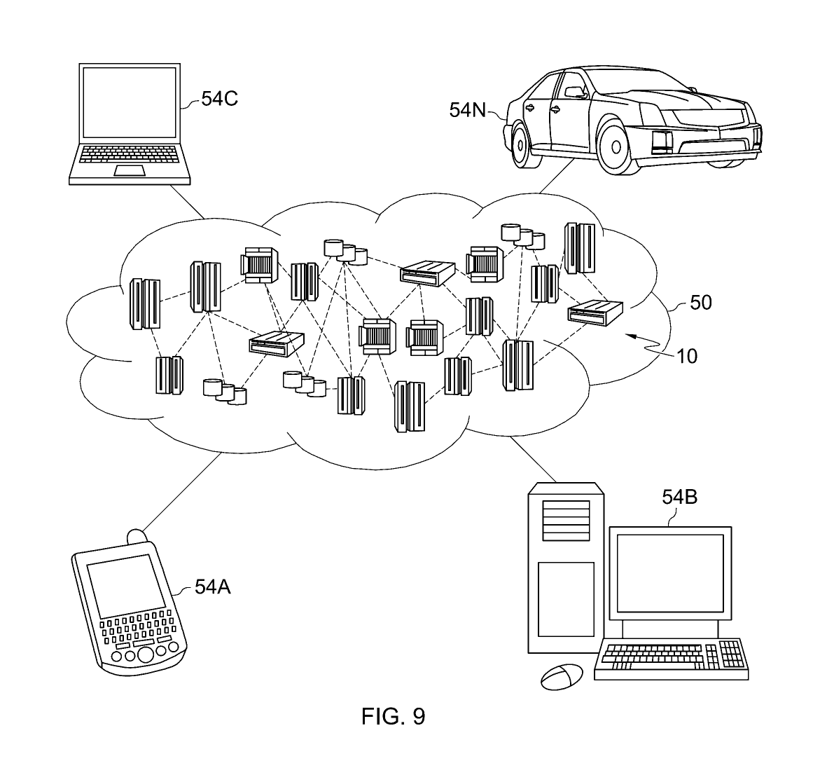

Referring now to FIG. 9, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

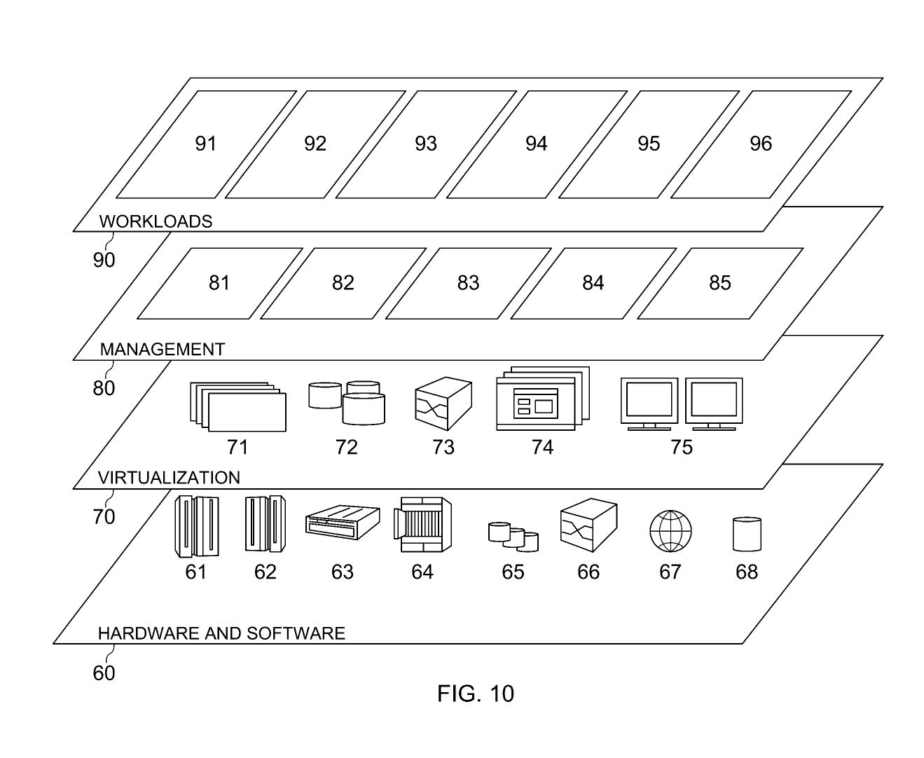

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment, including, e.g., dynamically and optimally provisioning middleware to host an application with one or more APIs in a PaaS layer of a cloud computing environment by executing one or more instructions of the application on a target platform having the least cost implication and/or lowest performance metric for running the application. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and mobile desktop processing 96.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for dynamically provisioning a target platform to host an application having one or more application program interfaces (APIs), the method comprising:
determining whether the one or more APIs are supported on one or more of at least two hosting platforms, wherein the hosting platforms have different performance metrics;
determining whether one or more instructions for the application are permitted to be executed on one or more of the hosting platforms; and
executing the one or more instructions for the application on the target platform, wherein the target platform has a lowest performance metric for running the application among one or more of the hosting platforms that supports the one or more APIs and on which the one or more instructions for the application are permitted to be executed.

2. The method according to claim 1, wherein the hosting platforms are provided in a PaaS layer of a cloud computing environment.

3. The method according to claim 2, wherein one of the hosting platforms is a mainframe platform.

4. The method according to claim 3, wherein at least one of the hosting platforms is a distributed platform.

5. The method according to claim 1, wherein the lowest performance metric for running the application is a lowest overall performance metric based on a comparison of a plurality of performance metrics for each of the hosting platforms.

6. The method according to claim 1, wherein the target platform has a lowest cost implication for running the application among the one or more of the hosting platforms that supports the one or more APIs and on which the one or more instructions for the application are permitted to be executed.

7. The method according to claim 1, wherein the application includes a runtime policy, and the determining whether the one or more instructions for the application are permitted to be executed on the one or more of the hosting platforms is based on the runtime policy, wherein the runtime policy includes at least one of a minimum response time, estimated transaction frequency, scalability, and availability.

8. The method according to claim 1, further comprising:
providing at least two middleware environments that are respectively associated with the at least two hosting platforms.

9. The method according to claim 1, wherein
the determining whether the one or more instructions for the application are permitted to be executed on one or more of the hosting platforms, and
the executing the one or more instructions for the application on the target platform
are repeated in response to each incoming request to execute the one or more instructions for the application.

10. The method according to claim 1, further comprising:
scanning the application for the one or more APIs.

11. The method according to claim 1, further comprising:
scanning the application for associated services; and
determining whether the associated services are supported on the one or more of the hosting platforms, and
wherein the target platform supports the associated services.

12. The method according to claim 1, further comprising:
evaluating response times from the hosting platforms; and
estimating transaction frequency information from the hosting platforms.

13. A computer program product for dynamically provisioning a target platform to host an application having one or more application program interfaces (APIs), wherein the target platform is selected from at least two hosting platforms having different performance metrics, the computer program product comprising at least one computer readable non-transitory storage medium having computer readable program instructions thereon for execution by a processor, the computer readable program instructions comprising program instructions for:
determining whether the one or more APIs are supported on one or more of the hosting platforms;
determining whether one or more instructions for the application are permitted to be executed on one or more of the hosting platforms; and
executing the one or more instructions for the application on the target platform, wherein the target platform has a lowest performance metric for running the application among one or more of the hosting platforms supports the one or more APIs and on which the one or more instructions for the application are permitted to be executed.

14. The computer program product according to claim 13, wherein the hosting platforms are provided in a PaaS layer of a cloud computing environment.

15. The computer program product according to claim 14, wherein one of the hosting platforms is a mainframe platform.

16. The computer program product according to claim 15, wherein at least one of the hosting platforms is a distributed platform.

17. A computer system for dynamically provisioning a target platform to host an application with one or more application program interfaces (APIs), the computer system comprising:
at least two hosting platforms, wherein the hosting platforms have different performance metrics;
at least one processor;
at least one computer readable memory;
at least one computer readable tangible, non-transitory storage medium;
and program instructions stored on the at least one computer readable tangible, non-transitory storage medium for execution by the at least one processor via the at least one computer readable memory, wherein the program instructions comprise program instructions for:
determining whether the one or more APIs are supported on one or more of the hosting platforms;
determining whether one or more instructions for the application are permitted to be executed on one or more of the hosting platforms; and
executing the one or more instructions for the application on the target platform, wherein the target platform has a lowest performance metric for running the application among one or more of the hosting platforms that supports the one or more APIs and on which the one or more instructions for the application are permitted to be executed.

18. The computer system according to claim 17, wherein the hosting platforms are provided in a PaaS layer of a cloud computing environment.

19. The computer system according to claim 18, wherein one of the hosting platforms is a mainframe platform.

20. The computer system according to claim 19, wherein at least one of the hosting platforms is a distributed platform.
